(19) United States
(12) Patent Application Publication
(10) Pub. No.: US 2013/0140812 A1
(43) Pub. Date: Jun. 6, 2013

(54) COUPLING ARRANGEMENT

(71) Applicants: Harvey William Lee, Sharjah (AE); Barry Robinson, Sharjah (AE)

(72) Inventors: Harvey William Lee, Sharjah (AE); Barry Robinson, Sharjah (AE)

(21) Appl. No.: 13/811,382

(22) PCT Filed: Jul. 21, 2011
(86) PCT No.: PCT/GB2011/001091

§ 371 Date: Feb. 12, 2013

(30) Foreign Application Priority Data
Jul. 21, 2010 (AE) P770-2010

(51) Int. Cl. F16L 37/14

(52) U.S. Cl. CPC F16L 37/14
USPC 285/308; 285/305

(57) ABSTRACT

A coupling assembly for connection to a fluid supply is provided. The assembly comprises a socket portion having a first part connectable to the supply and a second part connectable to an elongate member; a sealing means retained by the socket portion; and a locking means for locking the socket portion to the elongate member; wherein the locking means comprises a moveable portion moveable between a first unlocked position and a second locked position by slideably moving the moveable portion relative to the socket portion such that the locking means engages with a complementary portion of the elongate member.

### FIELD OF THE INVENTION

This invention relates to hose couplings. More particularly, this invention relates to a hose coupling for coupling a fluid hose to a fluid receptacle in underwater construction operations.

### BACKGROUND OF THE INVENTION

Hose coupling arrangements for grout delivery are very well known and widely used in the offshore oil exploration and drilling industries, particularly in underwater construction operations in these industries. Offshore oil drilling and exploration platforms typically include hollow steel legs, which are filled with grout in situ in order to stabilize the platform. In practice, the platform, which typically includes a plurality of hollow steel legs, would be towed by tug boats or the like to its intended location. Grout is then pumped into the hollow legs to weigh the platform down and stabilise it against heavy seas so that precision drilling work can be executed from the platform.

The coupling arrangements for the grout hoses typically comprise a female and a male part.

The platform legs feature hose coupling points to accept grout hoses extending from a surface supply ship. Typically, the grout hoses will be connected to the coupling points by divers or by way of Remotely Operated underwater Vehicles (ROVs) and the grout pumped down into the platform legs from the surface supply ship.

Existing coupling arrangements for offshore platforms include a male part, which typically includes a sealing arrangement, the male part being fixed to the platform and a female part, which typically includes a locking arrangement, the female part being fixed to a flexible hose. A serious disadvantage of this configuration is that maintenance or replacement of the sealing arrangement on the male coupling part necessarily entails underwater work, either by divers or employing ROVs, which is expensive, dangerous and time consuming.

### SUMMARY OF THE INVENTION

The invention aims to address these problems by providing a grout hose coupling arrangement for underwater construction operations which minimises the disadvantages of the known arrangements.

According to a first aspect of the invention, a hose coupling arrangement for underwater construction operations comprises a female part attachable to a hose and a complimentary male part attachable to a receptacle, the female part including a sealing arrangement and a locking mechanism for locking to the male part.

The locking mechanism may be in the form of a pin and groove arrangement, at least one movable pin member on the female part being adapted to engage a complimentary groove on the male part.

Preferably, the male part is in the form of a spigot having an inwardly extending groove around its periphery.

The pin and groove arrangement preferably includes a pair of oppositely located pins, movable by a lever, the pins being adapted to engage the groove on the male part on opposite sides of the male part.

The pins preferably include arced cut-outs, the pins being movable in relation to the groove on the male part between a released position wherein the arced cut-outs of the pins face the groove and a locked position wherein the cut-outs are laterally spaced from the groove, allowing the pins to key into the groove at opposite sides of the male part.

The female part preferably includes a socket formation with a flared mouth for accepting and guiding the male part.

The female part include a compression seal at its inner extremity against which the end of the male part abuts in sealing engagement, in use. The female part may further include an o-ring seal for sealing engagement against the male part.

In a preferred form of the invention, the receptacle to which the male part is attachable is in the form of an offshore drilling platform leg.

With the above arrangement, when the sealing or locking arrangements need repairs or maintenance, it can be easily done onshore or on the supply vessel. This is in contrast to the case where the male part, which includes a sealing arrangement, is submerged and fixed to the platform leg. In this case divers or ROVs need to be sent down to do the repairs or maintenance, with the dangers and high cost inherent with this type of work.

According to a second aspect of the invention, an offshore oil platform includes legs which feature at least one male part of a hose coupling which consist of a male part and a female part attachable to a hose, the female part including a sealing arrangement and a locking mechanism.

According to yet a further aspect of the present invention, there is provided a coupling assembly for connection to a fluid supply comprising: a socket portion having a first part connectable to the supply and a second part connectable to an elongate member; a sealing means retained by the socket portion; and a locking means for locking the socket portion to the elongate member; wherein the locking means comprises a moveable portion moveable between a first unlocked position and a second locked position by slideably moving the moveable portion relative to the socket portion such that the locking means or moveable portion engages with a complementary portion of the elongate member. The elongate member or plug conveys liquid to its destination via the socket which is connectable to the fluid supply. The locking means may releaseably lock the socket portion to the elongate member.

Preferably, the locking means is arranged to lock or unlock the socket to the elongate member such that the elongate member remains stationary with respect to the socket portion as the moveable portion locks or unlocks the socket to the elongate member. Usually, the elongate member is hollow. The elongate member is attached to a structure. Preferably, the structure is a hollow structure, in particular a platform such as an offshore platform having one or more hollow support members or legs. Preferably, the coupling assembly is suitable for subsea coupling. Preferably, the moveable portion comprises a locking pin. Preferably, the locking pin is substantially hexagonal in cross section. The moveable portion may be offset from a central axis of symmetry of the socket portion. The moveable portion may extend at least partially within the socket portion. The moveable portion may extend at least partially through a wall of the socket portion. The moveable portion may be substantially perpendicular to a longitudinal direction of the socket portion.

The socket portion may have a shape which forms a close fit around the spigot or elongate member. The socket portion may comprise a substantially rectangular member with a cut away portion which is preferably semi-circular in shape. The moveable portion comprises a cut out section. The cut out section extends from a side wall of the moveable portion or rectangular member towards a central axis of the movable portion or rectangular member. The moveable portion may be moved such that an outer wall of the moveable portion engages with a portion of the elongate member. The moveable portion may engage with a recessed portion of the spigot or elongate member. The cut out section has a shape which forms a close fit around the spigot or elongate member. The moveable portion may comprise a second locking pin. The second locking pin may be symmetrically mounted with respect to the longitudinal axis of symmetry of the socket portion. The second pin may lie in substantially same plane as first pin. The second pin may be substantially parallel to first pin. The first pin and second pin may be substantially perpendicular to the longitudinal axis of symmetry of the socket or coupling assembly. The moveable portion may further comprise a frame or rack. The frame may comprise a first side member fixedly attached to one end of the or each moveable portion. The frame may comprise a second side member fixedly attached to a second end of the or each moveable portion. The first or second side members may be substantially parallel to each other. Each side member may be substantially perpendicular to the movable portion(s). The side members may further comprise a portion extending beyond the main socket portion. The extending portion may extend beyond one side of the side member(s). A linking structure may join the side members. The linking structure may comprise an aperture extending through the linking structure. The aperture may be suitable for receiving a lever. The lever may extend beyond the aperture. The locking means may further comprise a lever. The lever may be arranged to pivot in a direction substantially perpendicular to the direction of one or both moveable portions.

The socket portion may further comprise a substantially elongate mouth portion or guide means for guiding the elongate member into the socket. The mouth portion may be substantially wider at one end of the mouth portion than at another end of the mouth portion.

Usually, the sealing means comprises a removable washer or o-ring. The sealing means may be a resilient sealing means. The sealing means may be replaceable. To achieve this, the sealing means may be deformable. The coupling assembly may further comprise a second sealing means. The second sealing means may be a removable washer or o-ring.

The second sealing means may be a resilient sealing means. The second sealing means may be is replaceable. To achieve this, the second sealing means may be deformable. The first or second sealing means may be a compression seal. In use, the compression seal contacts a terminal end of the spigot or elongate member. Usually, the sealing means is retained within a first groove. The first groove may be located at one end of the socket portion. The first groove may have 2 walls. The walls of the groove may have a different height. In use the terminal end of the spigot or elongate member compresses the first seal against one wall of the first groove. The second sealing means may be retained within a second groove. The first and second sealing means may be different sealing means. In use, the first sealing means may be compressed in a direction substantially perpendicular to the direction in which the second sealing means is compressed. The second groove may be located downstream from first groove with respect direction of fluid flow, in a direction from the top of FIG. 3 to the bottom of FIG. 3. Usually, the second groove is positioned about 5-8 mm away from the first groove. The second groove may be located at one end of the socket. The second groove may be substantially parallel to the first groove. The second groove and first groove may be substantially annular in shape. In use a side wall of the spigot or elongate member may compress the second sealing means against a bottom of the second grove. Usually, the socket portion or coupling assembly or both is substantially circular in cross section. Similarly, the elongate conveying member or plug or spigot is usually substantially circular in cross section.

According to yet a further aspect of the present invention, there is provided a coupling assembly for connection to a fluid supply comprising: an elongate member connectable to a hollow structure, wherein the elongate member has a hollow portion for conveying fluid from a fluid supply to the interior of the hollow structure, wherein the elongate member comprises a portion for engaging with a locking means of a socket portion.

### BRIEF DESCRIPTION OF THE DRAWINGS

An embodiment of the invention will now be described, by way of example only, and with reference to the accompanying drawings, in which:

FIG. 1 is a schematic, partly sectioned side view of a coupling arrangement according to the invention;

FIG. 2 is a side view of the female part of the arrangement of FIG. 1;

FIG. 3 is an end view of the female part of FIG. 2;

FIG. 4 is a schematic, sectioned top view of the one locking pin of the arrangement, showing the locking mechanism in a locked condition; and

FIG. 5 is a schematic, sectioned top view of the locking pin of FIG. 4, showing the locking mechanism in a released condition.

### DETAILED DESCRIPTION OF A PREFERRED EMBODIMENT

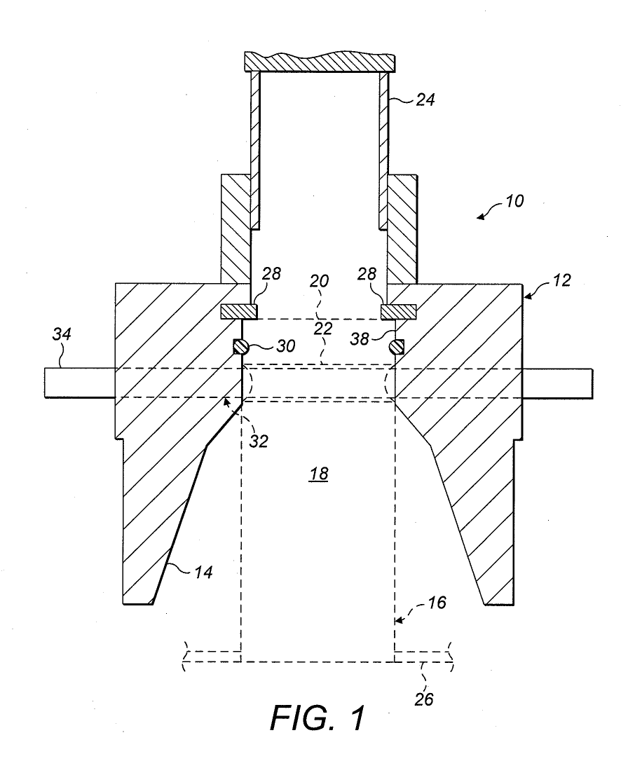

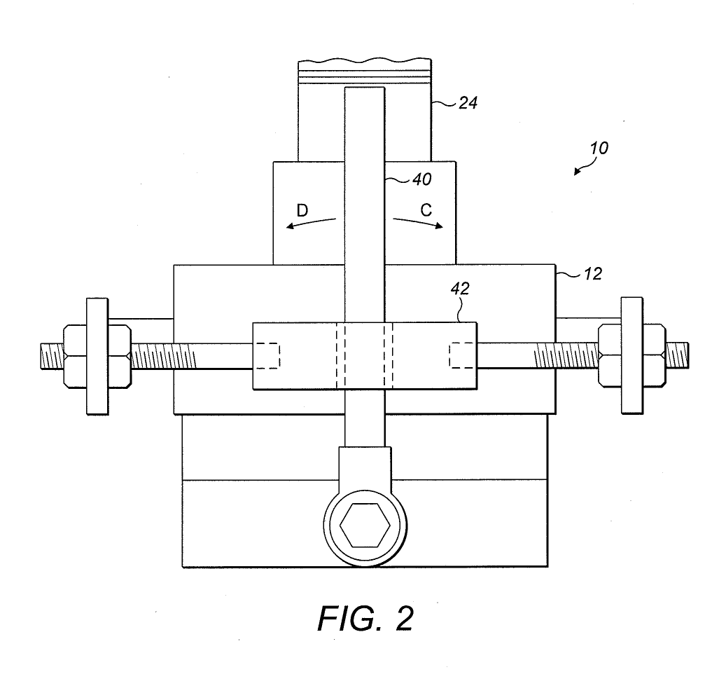

In FIGS. 1, 2 and 3, a coupling arrangement 10 is shown to comprise a female part 12, including a flared mouth 14 and a male part 16 in the form of a spigot having a terminal end 20 and an annular groove 22 located near its terminal end 20.

The female part 12 is connected to a flexible hose 24 and the male part 16 is permanently fixed to a hollow leg 26 of an offshore drilling platform (not shown).

The female part further includes a compression seal 28 against which the terminal end 20 of the male part sealingly abuts, in use, and an o-ring 30 as a secondary seal.

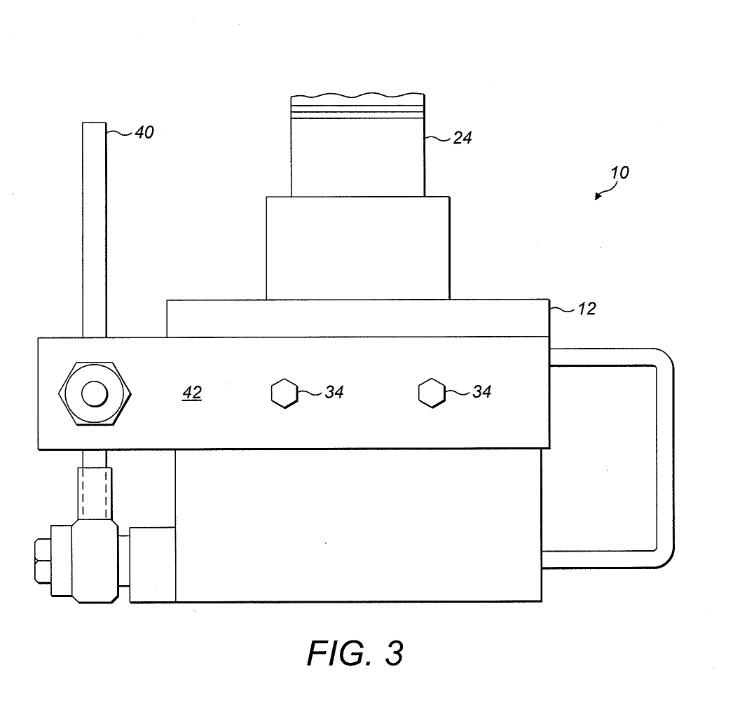

The female part 12 includes a locking mechanism 32 in the form of two locking pins 34 (see FIG. 3 for a clearer depiction of the relative positions of the two locking pins 34.) FIGS. 1, 4 and 5 all show one locking pin 34 only for purposes of illustration.

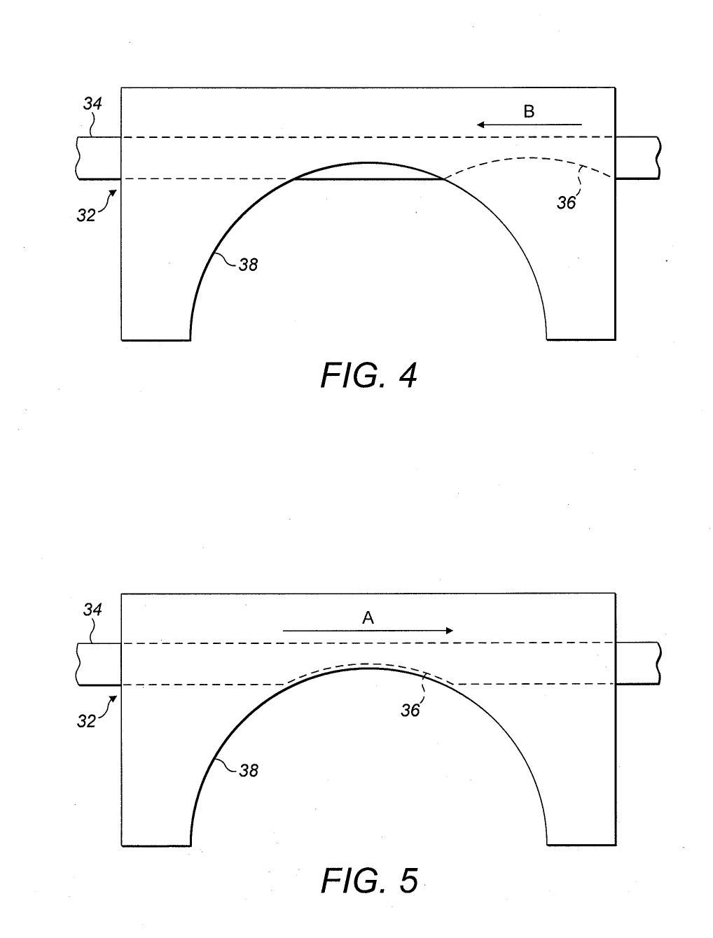

Each locking pin 34 includes an arced cut-out 36. In use, the male part 16 is inserted into a socket formation 38 inside the female part 12 with the locking pins 34 in their released position as shown in FIG. 5. This allows space for the male part 16 to enter the socket formation 38, with the cut-out 36 facing the socket formation 38. Once the male part 16 is in position, the pins 34 are moved in direction A until they are in their locked position as shown in FIG. 4. here, the cut-out no longer faces the socket formation 38 and the pins are keyed securely into the groove 22 of the male part.

To unlock the male part 16 from the female part 12, the pins are moved in direction B until the cut-outs 36 again face the socket formation 38 as shown in FIG. 5.

The pins 34 are movable by way of a simple lever 40 and rack device 42. Movement of the lever 40 in direction C causes the pins 34 to move in direction A and movement of the lever 40 in direction D causes the pins 34 to move in direction B. The lever 40 and rack 42 device is of a very simple mechanical design to allow divers (not shown) or ROVs (not shown) to manipulate the lever 40 to lock and unlock the female part 12 from the male part 16 easily and in difficult underwater conditions.

The hose coupling arrangement, or connector previously described has been designed so that:
A) Locking of male to female component is with one horizontal arm instead of two vertical pressure levers.
B) The whole structure is light and simple to operate subsea by a Diver or Remotely Operated Vehicle.
C) The arm is easy to operate in a single movement.
D) The male connection may be simpler and cheaper to manufacture as compared to known male connections which are relatively expensive dedicated male units.

Usually the coupling arrangement is manufactured using with high quality materials to avoid failure. The mass of the coupling unit may be approximately 22 kg. Further, the coupling may used by the offshore oil industry, but embodiments of the invention can also find application in the construction or maintenance of a pedestal for a wind turbine in a wind farm.

The sealing arrangements may be housed in the surface retrievable female part of the connector so that if a seal fails during operation, the unit can be uncoupled and quickly brought back to the surface for seal replacement. This is in contrast to other units available that require the seal on the pile connector replacing this can prove to be very difficult if not impossible when the jacket is all ready installed sub sea.

The sealing arrangement may comprise a two part seal. The sealing arrangement may further comprise a compression seal. The compression seal may be substantially flat. The seal may comprise a cam locking mechanism. The seal may be a two inch cam lock, flat compression seal forming the main sealing element. The seal may further comprise an o-ring seal, particularly 62 mm by 4 mm section, forming a secondary back up seal ring. Accordingly, embodiments of the invention are inexpensive and quick to repair.

The manufactured unit may be tested to 140 Bar normal operating pressure, but the typical operating pressure of the unit is 0.5-25 Bar.

1. A coupling assembly for connection to a fluid supply comprising:
a. a socket portion having a first part connectable to the supply and a second part connectable to an elongate member;
b. a sealing means retained by the socket portion; and
c. a locking means for locking the socket portion to the elongate member;
wherein the locking means comprises a moveable portion moveable between a first unlocked position and a second locked position by slideably moving the moveable portion relative to the socket portion such that the moveable portion engages with a complementary portion of the elongate member.

2. A coupling assembly according to claim 1 in which the locking means is arranged to lock or unlock the socket to the elongate member such that the elongate member remains stationary with respect to the socket portion.

3. A coupling assembly according to any preceding claim further comprising a lever pivotably connected to the coupling assembly for moving the movable portion, and in particular in which only a single lever is provided.

4. A coupling assembly according to any preceding claim in which the moveable portion can be moved in a direction substantially perpendicular to an elongate axis of the coupling assembly.

5. A hose coupling arrangement for underwater construction operations comprising a female part attachable to a hose and a complimentary male part attachable to a receptacle, the female part including a sealing arrangement and a locking mechanism for locking to the male part.

6. An arrangement as claimed in claim 5 wherein the locking mechanism is in the form of a pin and groove arrangement, at least one movable pin member on the female part being adapted to engage a complimentary groove on the male part.

7. An arrangement as claimed in claim 5 or 6 wherein the male part is in the form of a spigot having an inwardly extending groove around its periphery.

8. An arrangement as claimed in claim 6 or 7 wherein the pin and groove arrangement includes a pair of oppositely located pins, movable by a lever, the pins being adapted to engage the groove on the male part on opposite sides thereof.

9. An arrangement as claimed in any one of claims 6 to 8 wherein the pins include arced cut-outs, the pins being movable in relation to the groove on the male part between a released position wherein the arced cut-outs of the pins are aligned with the groove and a locked position wherein the cut-outs are laterally spaced from the groove, allowing the pins to key into the groove at opposite sides of the male part.

10. An arrangement as claimed in any one of claims 5 to 9 wherein the female part includes a socket formation with a flared mouth for accepting the male part.

11. An arrangement as claimed in any one of claims 5 to 10 wherein the female part includes a compression seal at its inner extremity against which the terminal end of the male part abuts in sealing engagement, in use.

12. An arrangement as claimed in any one of claims 5 to 11 wherein the female part further includes an o-ring seal for sealing engagement against the male part.

13. An arrangement as claimed in any one of claims 5 to 12 wherein the receptacle to which the male part is attachable is in the form of an offshore drilling platform leg.

14. An offshore oil platform including legs which feature at least one male part of a hose coupling which consist of a male part and a female part attachable to a hose, the female part including a sealing arrangement and a locking mechanism.

15. A coupling assembly for connection to a fluid supply comprising:
a. an elongate member connectable to a structure, wherein the elongate member has a hollow portion for conveying fluid from a fluid supply to the structure, wherein the elongate member comprises a portion for engaging with a locking means of a socket portion.
